(19) United States
(12) Patent Application Publication
(10) Pub. No.: US 2008/0216637 A1
(43) Pub. Date: Sep. 11, 2008

(54) Method for Keying Human Voice Audio Frequency

(75) Inventor: Wen-Hsin Lin, Taiwan (CN)

Correspondence Address: EGBERT LAW OFFICES, 412 MAIN STREET, 7TH FLOOR, HOUSTON, TX, 77002, US

(73) Assignee: Tio-Pin Cultural Enterprise Co., Ltd, Taiwan (CN)

(21) Appl. No.: 12/089,179

(22) PCT Filed: Oct. 19, 2005
(86) PCT No.: PCT/CN2005/001711

§ 371 Date: Apr. 3, 2008

(51) Int. Cl. G10H 1/36

(52) U.S. Cl. 84/610

(57) ABSTRACT

A method for keying human voice audio frequency includes the steps of setting the human factor of the singer; recording the singing of the singer; calculating the audio frequency by an audio frequency counter; recording the maximum ground frequency by the recorder; estimating a maximum fundamental audio frequency thereof by the diapason estimator; and converting the maximum fundamental audio frequency into musical terminology, the best audio frequency of the singer being determined. The method for keying human voice audio frequency is very easy and fast.

### BACKGROUND OF INVENTION

1. Field of the Invention

The present invention relates generally to an audio tuning method, and more particularly to an improved one which could estimate the maximum audio frequency of the testees, and then tune and determine the key of music suitable for their singing range.

2. Description of Related Art

The common music lovers are often unaware of their suitable key or vocal range. So, they couldn't sing easily, or sing in tune with the instruments when the tone of instruments or music is too high or low, especially in occasions with accompanies music (e.g. Karaoke, KTV), where the tune of accompanied songs is often out of tune with their key. Moreover, the singers who are intended to attend large operas or concerts have to repetitively call their own tune in cooperation with the orchestra, leading to frequent and time-consuming test of tune prior to performance. Besides, the audio frequency of a person may fluctuate within a certain period of time, a bigger frequency means a higher tone, and vice versa. And, the audio frequency may change with the varying climate, mood, physical state and time as well as the gender and age. So, even if the singers are well aware of their own vocal range, or the trial matching with the orchestra is satisfactory, deviation or mistuning or undesired performance may occur due to different environments and physical conditions.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### CONTENT OF THE INVENTION

The major purpose of the present invention is to an audio tuning method, and more particularly to an improved one which could determine quickly and accurately the audio frequency of a person, and then tune the key of music suitable for singing.

The other purpose of the present invention is to apply audio tuning method and programmed language to develop a computer-aided functional software that can be accessed and operated through an interface; also, it can be widely applied to various electronic equipments or musical instruments or Internet, thus shaping an audio tuning hardware.

### SUMMARY OF THE INVENTION

1. Based upon the innovative design of the audio tuning method of the present invention, it is possible to measure easily and quickly the optimum vocal range of the testee, obtain accurately the key and then tune it in line with the vocal range for easy singing.
2. The present invention could be used to detect accurately the audio frequency of the singer and avoid trial matching with the orchestra, or enable the singer to measure the optimum vocal range prior to formal performance, thus preventing any deviation of vocal range from the orchestra or the key of accompanied music due to varying physical conditions, climate, mood and time, and achieving the purpose of perfectly matching with the orchestra or accompanied music for optimum performance.

Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG. 1 shows a flow process chart of audio tuning method of the present invention.

FIG. 2 shows a flow process chart of vocal range estimator of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

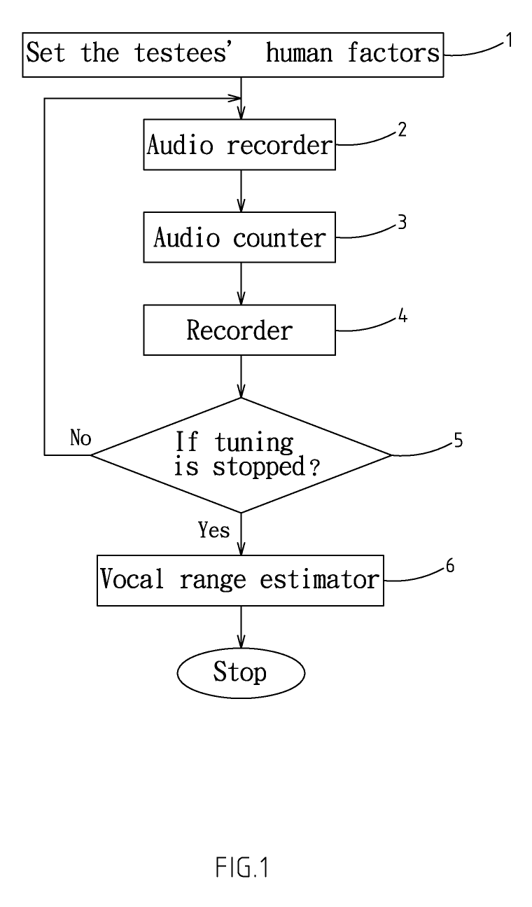

FIGS. 1˜2 depict preferred embodiments of audio tuning method of the present invention. The present invention permits to detect continuously the audio frequency and record the maximum audio frequency in the singing process, and then estimate the suitable vocal range of the singer to determine a suitable key. Referring to FIG. 1, it is firstly required to set the testees' human factors 1, which comprises: “the key of female or male”, and receiving music training or not, of which the key also includes the key of younger girls or boys; next, the voice of the testee is recorded continuously by an “audio recorder” 2, and the fundamental frequency of voice is calculated by an “audio counter” 3; then, a “recorder” 4 is used to compare the fundamental frequency and records the maximum fundamental frequency, and finally judge “if tuning is stopped” 5; if yes, the maximum fundamental frequency is estimated by the “vocal range estimator” 6 to determine the vocal range and complete the tuning process; otherwise, return to “audio recorder” 2 for recording test.

The aforementioned “audio recorder” 2 is a digital recorder, which transforms audio signals into digital voice data with a duration about 0.1 second; then, the “audio counter” 3 calculates the fundamental frequency of the voice from the max. autocorrelation function; the “recorder” 4 is used to record the max. or min. fundamental frequency; and the “vocal range estimator” 6 could estimate the maximum audio frequency suitable for the testee so as to determine the key of entire song.

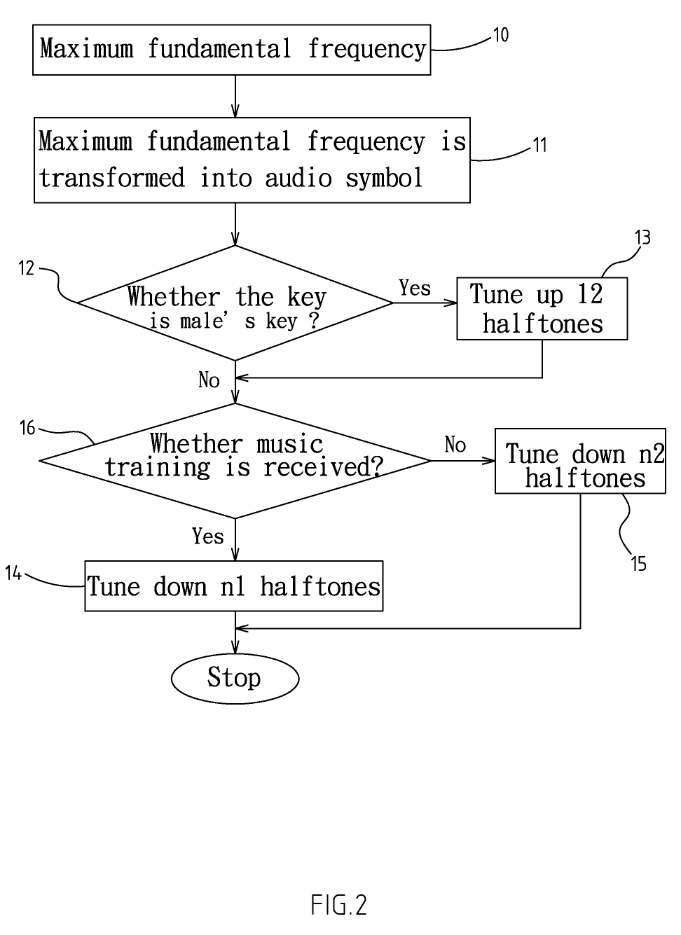

The algorithm of the “vocal range estimator” 6 is described below: Assuming that the maximum fundamental frequency recorded by the above-specified “recorder” 4 is the maximum fundamental frequency suitable for the testee, as shown in FIG. 2:

1. Transforms the maximum fundamental frequency 10 into an audio symbol 11, which is set as X.

2. For the key of male 12, let X=X+12 half-tones (one 8 degree), namely, key is high up to 12 half-tones 13.

3. If music training 16 is received, the maximum tone suitable for singing is X—n1 half-tones, namely, key is low to n1 half-tones 14.

4. If no music training 16 is received, the maximum tone suitable for singing is X—n2 half-tones, namely, key is low to n2 half-tones 15.

Of which, n1, n2 is an empirical value≧0, and obtained from actual test.

Based on above-specified steps, the preferred embodiments and efficacy of the present invention are described below:

Referring to FIG. 1, it is firstly required to set the “key of female or male” for the testee, and then set if he/she has received “music training or not”; then, start recording test; for example, let the testee sing a bit of a song and then raise the tone gradually until the testee feels satisfactory; or let the testee sing a high note, and then raise the note gradually until the testee finds it difficult to raise it any more. In such case, n1, n2 empirical value may differ a little. In the step of “audio recorder” 2, set the voice format as single-tone 16 bits, sampling frequency of 44100 Hz, recording length of 0.1 second per time; next, in the step of “audio counter” 3, the audio frequency is calculated by the following methods. Assuming the recorded voice is x(n),

n=0, 1, 2 . . . , N−1, N=4410,

1. Calculate autocorrelation function rₓ(k), of which

rₓ(k)=ₙx(n)x(n−k),n=0,1,2 . . . , N−1,
k=22, 23, 24, . . . , 674
The range of k represents the frequency range to be detected:
44100/22˜44100/674=2004.54˜65.43 Hz

2. Search for kₘₐₓ=arg(max(rₓ(k))/ₖ), kₘₐₓ represents k value when rₓ(k) is max. value

3. Fundamental frequency f₀=44100/kₘₐₓ

Then, “recorder” 4 is used to record the maximum fundamental frequency, and repeat steps “audio recorder” 2 to “recorder” 4 until completion of test. Finally, “vocal range estimator” 3 (shown in FIG. 2) is used to estimate the suitable maximum audio frequency. If assuming the maximum fundamental frequency is 440 Hz, it is transformed into audio symbol of A4. If assuming the key is male's key, the maximum fundamental frequency is transformed into audio symbol of A5; assuming that no music training is received, and n2=3, the suitable maximum tone is F^{#}5. The maximum tone of a song shall be tuned for not exceeding F^{#}5.

The audio tuning method of the present invention along with programmed language could be used to develop an electronic element and processor that enables recording, store and calculation through an interface; also, it can be widely applied to various electronic equipments or musical instruments or Internet, thus shaping an audio tuning hardware.

1. An audio tuning method, comprising the steps of:
setting human factors of a singer;
recording singing by said singer concurrent with calculating audio frequency by an audio counter;
recording a fundamental frequency by a recorder;
estimating a suitable audio frequency by a vocal range estimator; and
transforming into an audio symbol to obtain an optimum audio frequency;
wherein a maximum fundamental frequency of said singer is transformed into an audio symbol, for a male, singer, said key being raised for up to 12 half-tones, X=X+12 half-tones (one 8 degree), for a male singer with music training, said key being lowered to n1 half-tones, a maximum tone suitable for singing being X—n1 half-tones, for a male singer without music training said key being lowered to n2 half tones, said maximum tone suitable for singing is X—n2 half-tones, wherein n1 and n2 each have an empirical value ≧0, obtained from an actual test.

2. The method defined in claim 1, wherein said recorder is a digital audio recorder.

3. The method defined in claim 1, wherein said human factors are comprised of “female or male”.

4. The method defined in claim 1, wherein said human factors are further comprised of “music training is received or musical training not received”.

5. The method defined in claim 1, wherein said maximum fundamental frequency is set by a programmed language, an electronic element and processor enabled for recording, storage and calculation through an interface being applied to electronic equipment, musical instruments or Internet, shaping an audio tuning hardware.
